(19) United States
(12) Patent Application Publication
(10) Pub. No.: US 2025/0146621 A1
(43) Pub. Date: May 8, 2025

(54) PROCESS FOR PRODUCTION OF A SEALED TANK TO CONTAIN A GAS AND/OR A FLUID

(71) Applicant: L'Air Liquide, Société Anonyme pour l'Etude et l'Exploitation des Procédés Georges Claude, Paris (FR)

(72) Inventor: Philippe Papin, Bievres (FR)

(21) Appl. No.: 18/938,807

(22) Filed: Nov. 6, 2024

(30) Foreign Application Priority Data
Nov. 8, 2023 (FR) 2312150

(51) Int. Cl. F17C 1/16

(52) U.S. Cl. CPC F17C 1/16; F17C 2201/0109; F17C 2203/0668; F17C 2203/0673; F17C 2209/2163; F17C 2209/232; F17C 2221/012; F17C 2223/036

(57) ABSTRACT

An aspect of the invention concerns a process for production of a sealed tank in order to contain a gas and/or a liquid, including a step of formation of a sealed wall of the tank, having the following sub-steps: forming an envelope by application of at least one knitted item covering the outer surface of the mandrel, the knitted item having knitted threads of a thermoplastic material which can be sealed by heat; filament winding, around the envelope, of successive sections of a first strip comprising a thermoplastic material which can be sealed by heat and is reinforced by fibres, such as to melt the successive wound sections of the first strip; and cooling the envelope and the first strip in order to form the sealed wall in a single material.

### CROSS REFERENCE TO RELATED APPLICATIONS

This application claims the benefit of priority under 35 U.S.C. § 119 (a) and (b) to French Patent Application No. 2312150, filed Nov. 8, 2023, the entire contents of which are incorporated herein by reference.

### TECHNICAL FIELD OF THE INVENTION

The technical field of the invention concerns processes for production of sealed tanks, or sealed containers, in particular, but not limited to, pressurised tanks made of composite material.

The present invention concerns a process for production of a sealed tank using thermoplastic materials reinforced by fibres in the production process.

### Technological Background of the Invention

The conditions for storage of gas or liquid have recently been improved with the appearance of composite sealed tanks which comprise a fibrous material, i.e. which are reinforced by fibres, as a wall structure or outer envelope.

“Sealed tank” means a tank or container which is sealed against liquids and/or gases. More specifically, it means a tank which has, for these liquids and/or these gases, a permeability which is lower than a maximal limit prescribed by the application.

For example, a sealed tank which is designed for an application of transport of hydrogen in compressed form at high pressure has permeability to the hydrogen, when this gas is compressed, in a pressure range going from 30 MPa to 70 MPa (i.e. from 300 bars to 700 bars).

In order to permit the storage of hydrogen in these pressure conditions, it is known to use a sealed tank architecture known as type III or IV. This architecture comprises, from the interior towards the exterior, a sealed cylinder, also known as an “inner liner” according to the terminology currently used, and an outer reinforcement structure produced by means of filament winding.

The purpose of the inner liner is mainly to assure a function of sealing of the gas (it must be as impermeable as possible to the hydrogen). The purpose of the outer reinforcement structure is mainly to assure a function of mechanical resistance to the pressure.

In the tanks of type Ill, the inner liner is made of metal. In the tanks of type IV, the inner liner is made of polymer, and is produced by roto-moulding or by extrusion-blowing for example.

A new type of tank is described in document WO2011143723A2. The sealing of the gas is provided there other than by means of an inner metal liner. The liner is thus replaced by an inner sealed envelope formed by winding and heating a covering strip formed by a thermoplastic material which can be sealed by heat around a template (or mandrel). This template is made of metal, and can be dismantled into multiple hoops which fit circumferentially with one another, thus allowing it to be removable and reusable. The template also has a form which corresponds to the form of the tank Typically, the template has a cylindrical form, and, on each axial side, a rounded frontal facet in the form of a cap.

In order to assure the mechanical strength, and to consolidate the barrier against the gases, the sealed inner envelope is protected by a second envelope, known as the protective outer envelope, also produced from a wound strip, comprising a thermoplastic material which can be sealed by heat and is reinforced by fibres which are preferably continuous. This second envelope constitutes the outer reinforcement structure of the sealed tank.

Like the inner envelope, this outer envelope is formed by winding a covering strip on the first envelope (which thus acts as a mandrel), with the material of the wound covering strip being the thermoplastic material reinforced by the fibres. The resulting sealed wall of the sealed tank thus comprises two components (the inner envelope and the outer envelope).

Since the inner sealed envelope formed from the wound strip of thermoplastic material is far lighter, and also less costly, than a liner (made of metal but also polymer), its use makes it possible to lighten considerably the mass of the tank, and to reduce its cost.

This advantage is however balanced against the increase in the time for production of the sealed tank, since the winding of the covering strip during production of the sealed inner envelope takes a lot of time. In fact, since the covering strip is narrow and thin in comparison with the dimensions of the template and the desired thickness of the sealed inner envelope, it must be wound in multiple turns around the template. Specifically, the covering strip is wound so as to form a plurality of superimposed turns which overlap longitudinally and radially, thus forming a plurality of layers around the template. In addition, the winding speed is constrained by the drawing and the pressure to be exerted on the covering strip in order for the first layer to be well-clamped on the template, and for the successive layers to be clamped relative to one another. This makes it possible to avoid air bubbles between each turn and layer during the heating step, which makes it possible to melt or soften the turns relative to one another in order to consolidate them.

For example, several hours are needed to wind a strip with a thickness of 120 μm to 150 μm and a width of 25 mm to 80 mm around a cylindrical template with a diameter of 60 cm and a length of 3.50 m, onto a thickness of between 2 mm and 5 mm. A duration of this type holds up the deployment of the production process on an industrial scale.

There is therefore a need to speed up the production of a sealed tank, in particular a sealed tank which does not comprise an inner liner.

### SUMMARY OF THE INVENTION

The invention provides a solution to the problems previously described, by making it possible to obtain a sealed wall in a single step of winding of a material containing fibres.

A first aspect of the invention concerns a process for production of a sealed wall of a sealed tank, the sealed tank being designed to contain a gas and/or a liquid, with the production process comprising the following steps:
Fitting a reusable and removable mandrel by fitting/dismantling of hoops, the mandrel having an outer surface with a form corresponding to an inner surface of the sealed wall of the tank;
Forming the sealed wall of the tank on the outer surface of the mandrel, while forming an orifice for extraction of the mandrel;
Removing the mandrel from the sealed wall through the extraction orifice.
   The step of forming the sealed wall is performed by carrying out the following sub-steps of:
Forming an envelope by application of at least one knitted item covering the outer surface of the mandrel, the knitted item comprising a layer of knitted threads forming loops, the knitted threads being made of a thermoplastic material which can be sealed by the addition of heat;
Winding, around the envelope formed by the knitted item covering the outer surface of the mandrel, of successive sections of a first strip comprising a thermoplastic material which can be sealed by the addition of heat and is reinforced by fibres, such that the successive sections of first wound strip overlap in order to form a first layer of first strip, and overlap in order to form superimposed layers of first strip, the winding being carried out by:
   Exerting a pressure selected to clamp each section of the first wound strip against the envelope, forming the first layer of first strip, and to clamp the sections covering the first layer of first strip, in order to form the other superimposed layers of first strip, and by:
   Applying a temperature selected to melt the thermoplastic material of each section of the first layer of first strip together with the underlying threads of the envelope, and in order to melt the sections of the successive layers of first strip;
Cooling the envelope and the first wound strip in order to form the sealed wall in a single material.

Thus, the preliminary use of a knitted item, the threads/loops of which are made of a thermoplastic material compatible with the thermoplastic material of the first strip (with the two components melting under the combined effect of the pressure and the temperature applied during the winding), advantageously makes it possible to dispense with a highly time-consuming step, of winding of a strip of thermoplastic material around the mandrel. The process of production of the sealed wall of a sealed tank is thus faster than the solution proposed by the document according to the prior art.

In fact, a single knitted item (or a single layer of knitted threads) provides enough thermoplastic material, by melting with the first strip, to create an effect of a barrier against the gas, with the same mechanical resistance to pressure as the sealed inner envelope of the tank according to the prior art. Since the knitted item is produced previously, it does not need to be formed during the process of production of the tank, contrary to the sealed inner envelope of the tank according to the prior art. The knitted item is also quick and easy to apply to the mandrel, since it can simply be slipped onto it, for example manually.

In addition, thanks to the threads/loops of the knitted item which are made of a thermoplastic material compatible with the thermoplastic material of the first strip, the sealed wall obtained is in a single piece, i.e. formed from a single material. In other words, once the winding by the first strip has been completed, it is not possible to distinguish the components used (the knitted threads and the thermoplastic material which impregnates the reinforcement fibres). In comparison with a sealed wall composed of two, inner and outer envelopes (such as those presented in the solutions according to the prior art), this homogeneousness of the sealed wall makes it possible to improve the strength of the tank.

Specifically, the sealed wall of the tank in a single piece is more resistant than a double-layer wall, when a vacuum or depressurisation are applied to the interior of the sealed tank. Since these conditions of pressure and temperature are those encountered during phases of drying and decontamination of the tank, or during emptying phases, the sealed tank obtained is better suited to its use, and has a longer service life.

In addition to the characteristics which have just been described in the preceding paragraphs, the process according to the first aspect of the invention can have one or a plurality of complementary characteristics from amongst the following, taken into consideration individually, or according to all the combinations technically possible:
the thermoplastic material of the knitted threads is identical to the thermoplastic material of the first strip;
the knitted item has a mass per surface area of between 100 g/m² and 800 g/m²;
the knitted item is in the form of one or a plurality of sleeves, each sleeve being slipped onto an end of the mandrel.
the sub-step of formation of the envelope also comprises the application of a second knitted item onto the first knitted item, with the thermoplastic material of the knitted threads of the second knitted item being able to be sealed by addition of heat under the same temperature and pressure conditions as the thermoplastic material of the knitted threads of the first, underlying knitted item;
the sub-step of winding around the envelope comprises winding of at least one other additional strip, formed by the material of the first strip, with the additional strip being wound simultaneously with the first strip.

A second aspect of the invention concerns a process for production of a reinforced sealed wall of a tank comprising the steps of the process of the sealed wall previously described, with or without the different embodiments, comprising the following sub-steps:
Winding, around the sealed wall, of successive sections of a second strip comprising a thermoplastic material which can be sealed with heat, and is reinforced by fibres, such that the successive sections of the second wound strip overlap in order to form a first layer of the second strip, and overlap in order to form superimposed layers of the second strip, the winding being carried out by:
   Exerting pressure selected in order to clamp each section of the second wound strip against the sealed wall, forming the first layer of second strip, and in order to clamp the sections overlapping the first layer of the second strip in order to form the other superimposed layers of second strip; and by
   Applying a temperature selected in order to melt the thermoplastic material of each section of the first layer of second strip together with the underlying region of the sealed wall, and to melt the sections of the successive layers of second strip;
Cooling of the sealed wall and of the second strip in order to form the reinforced sealed wall made of a single material.

Thus, the sealed wall of the tank is reinforced with fibres and thermoplastic material. This makes it possible to increase the sealing and the mechanical resistance to pressure of the tank.

Advantageously, the thermoplastic material of the knitted threads of the knitted item is identical to the thermoplastic material of the first strip.

Thus, the envelope and the second wound strip are joined in the most perfect way possible.

A third aspect of the invention concerns a process for production of a sealed tank to contain a gas or liquid, comprising the following steps:
Producing a sealed wall of the tank by carrying out the steps of the production process according to the first aspect of the invention, with or without the different embodiments previously described;
Closing the sealed wall by applying a bottom against the sealed wall;
Consolidating the sealed wall in order to obtain a reinforced sealed wall of the tank, with the step for consolidation of the sealed wall being carried out by performing the following sub-steps of:
   Winding, around the sealed wall, of successive sections of a second strip comprising a thermoplastic material which can be sealed by heat, and is reinforced by fibres, such that the successive sections of second wound strip overlap in order to form a first layer of second strip, and overlap in order to form superimposed layers of second strip, the winding being carried out by:
   Exerting pressure selected in order to clamp each section of the second wound strip against the sealed wall, forming the first layer of second strip, and in order to clamp the sections overlapping the first layer of second strip in order to form the other superimposed layers of second strip; and by
   Applying a temperature selected in order to melt the thermoplastic material of each section of the first layer of second strip together with the underlying region of the sealed wall, and to melt the sections of the successive layers of second strip;
Cooling of the sealed wall and of the second strip in order to form the reinforced sealed wall made of a single material.

The thermoplastic material of the second strip is thus chemically compatible with the underlying region of the sealed wall, for melting together.

According to one embodiment, the thermoplastic materials of the first and second strips are identical.

According to one embodiment, the bottom has a peripheral outer surface covered by a thermoplastic material which can be sealed by heat, and is compatible with the thermoplastic material of the sealed wall. According to one example, the peripheral surface of the bottom is heated before the closure step, in order to melt with an inner peripheral surface of the sealed wall defining the extraction orifice during the step of closure of the sealed wall.

According to one embodiment, the outer surface of the bottom is covered by the second strip during the said step of consolidation of the sealed wall.

The invention and the various applications thereof will be better understood from reading the following description and from studying the accompanying figures.

### BRIEF DESCRIPTION OF THE FIGURES

The figures are provided by way of indication, and in no way limit the invention.

FIG. 1 represents in the form of a logic diagram the main steps of a process for production of a sealed tank according to an aspect of the invention;

FIG. 2 is a schematic representation in cross-sectional view of a sealed tank obtained according to the production process represented in FIG. 1;

FIG. 3 represents in the form of a logic diagram the main steps of the process for production of a sealed wall, i.e. the first step of the production process represented in FIG. 1;

FIG. 4 represents in schematic form an example of a mandrel used during the production process represented in FIG. 3;

FIG. 5 represents in the form of a logic diagram the second step of the production process represented in FIG. 3;

FIG. 6 represents in schematic form an example of a knitted item used during the step represented in FIG. 5;

FIG. 7 represents in schematic form a semi-finished sealed wall in production during the first sub-step of the step represented in FIG. 5;

FIG. 8 represents in schematic form the second sub-step of the step represented in FIG. 5;

FIG. 9 represents in schematic form a block forming the sealed wall surrounding a mandrel during the third sub-step of the step represented in FIG. 5;

FIG. 10 represents in schematic form a sealed wall obtained after the third step of the production process represented in FIG. 3;

FIG. 11 represents in schematic form a semi-finished tank during the second step of the production process represented in FIG. 1;

FIG. 12 represents in the form of a logic diagram sub-steps of the third step of the production process represented in FIG. 1;

FIG. 13 represents in schematic form the first sub-step of the step represented in FIG. 11;

FIG. 14 represents in schematic form a sub-step which is an alternative to the first sub-step represented in FIG. 13;

FIG. 15 represents in schematic form a tank obtained after the second sub-step of the step represented in FIG. 12.

### DETAILED DESCRIPTION OF THE PREFERRED EMBODIMENTS

Unless specified to the contrary, the same element appearing in different figures has the same unique reference.

The present invention comes within the context of sealed tanks and their production processes. More particularly, the objective of the invention is to produce more rapidly sealed tanks with resistance to pressure greater than 0.2 MPa, and characteristics of a barrier against gas (permeability to the gas/or to the liquid to be contained in the sealed tank) which are similar to, or better than, those of the solutions of the prior art.

An example of an embodiment of a process 200 for production of a sealed tank according to the invention is illustrated in the form of a logic diagram in FIG. 1.

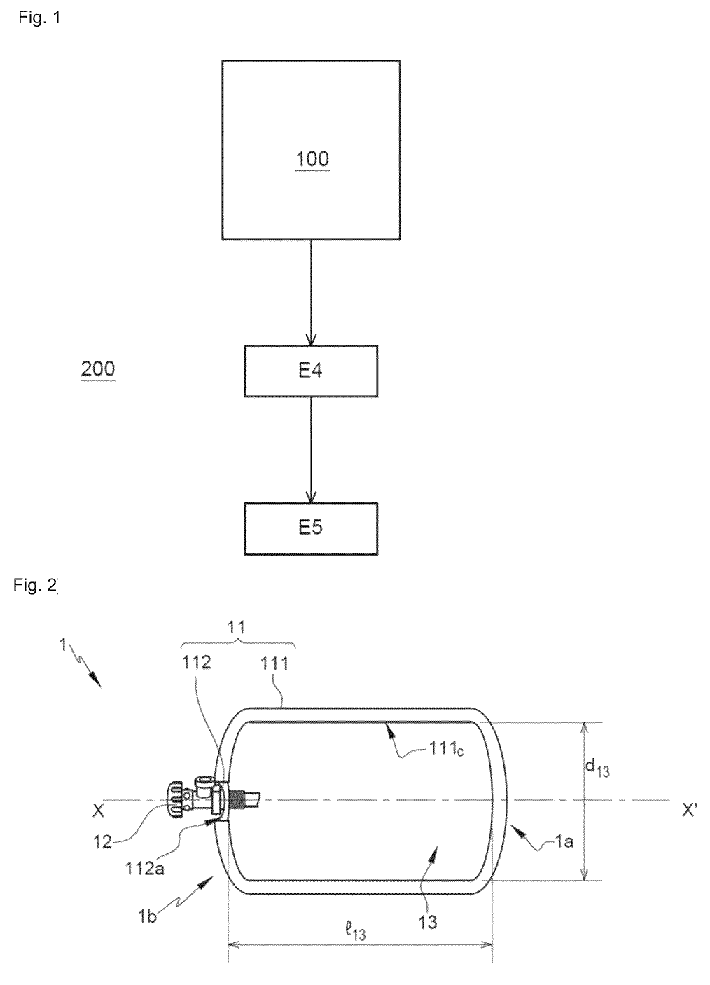

The process 200 for production of a sealed tank is preferably used to produce the sealed tank 1 (also known as the “tank 1” hereinafter), an enlargement of a cross-section of which is represented schematically in FIG. 2.

In particular, the tank 1 is a composite tank designed for use in the field of transport and delivery of hydrogen under high pressure.

The expression “composite tank” designates a type of tank in which the function of sealing against the gas is provided by a thermosetting material, and the function of mechanical resistance to pressure is provided by fibred reinforcements. The tank 1 is thus designed to contain hydrogen kept at a high pressure of 700 MPa or more. In this case, the tank is also designed to contain a liquid such as water. It will be appreciated that, in other examples, the tank 1 can be designed to contain other gases and/or other liquids, in conditions of atmospheric storage or under pressures lower than 700 MPa.

As shown by FIG. 2, in this case, the sealed tank 1 has a cylindrical interior and exterior form, in this example along a single longitudinal axis XX′. The exterior form and the interior form can have an axis which is offset from one another, for example parallel to one another. The tank 1 comprises a flank on each axial side 1a, 1b, known as the frontal facet, which is rounded, in the form of a dome or a cap. In other examples, the form of the tank 1 can be different, for example spherical, ellipsoid, or with other forms.

In the following description, the terms “interior”, “exterior”, “inner” and “outer” are used to designate the position of a part or of a surface relative to the longitudinal axis XX′ of the tank 1, with an interior or inner surface (for example) being closer to the longitudinal axis than an exterior or outer surface. The term “axial” means “in the direction of the longitudinal axis”, and the terms “radial” and “transverse” mean “in a direction perpendicular to the longitudinal axis”. The term “lateral” means “situated on the sides of a part extending radially”. The terms “thickness” and “diameter” designates dimensions measured radially. The term “length” designates a dimension measured axially.

More specifically, and again with reference to FIG. 2, the tank 1 comprises a wall 11 and an interior volume 13. In this example, the tank 1 comprises a joining piece 12.

The interior volume 13 of the tank 1 can in this example have a diameter d₁₃ of 60 cm and a length 113 of 3.50 m.

The joining piece 12 of the tank 1 is for example a tap 12 which makes it possible alternately to close/open the passage of the gas or the liquid into/out of the tank 1.

The wall 11 of the tank 1 has a sealed wall 111, and, in this example, a bottom 112 positioned on one of the axial sides 1b of the tank 1.

The sealed wall 111 of the wall 11 of the tank 1 has an inner surface 111c which has the form of the interior volume 13 of the tank 1.

The sealed wall 111 is formed by a composite material, i.e. it comprises a mixture of at least one thermoplastic material and at least one fibrous material. The sealed wall 111 provides both the inner barrier effect (impermeability) against the gas or liquid contained in the interior volume 13 of the tank 1, and the effect of mechanical resistance to pressure. The thermoplastic material(s), as well as the type of fibres of the sealed wall 111 will be described hereinafter, in relation with the process 100 for production of the tank 1.

The bottom 112 of the wall 11 of the tank 1 preferably has an annular form, i.e. it has an interior passage which is designed to receive the joining piece (the tap) 12.

In the example of the tank 1 illustrated in FIG. 2, the bottom 112 advantageously has a curved outer surface 112a, the periphery at least of which is positioned in the thickness of the sealed wall 111 (not shown in FIG. 2), as explained hereinafter. Thus, the sealed wall 111 and the bottom 112 forming the tank 1 form a single rigid structure which can withstand the pressures required by the application.

The process 200 for production of the tank 1 is described hereinafter in relation with FIGS. 1 to 15.

As shown by FIG. 1, the process 200 for production of the tank 1 comprises the following successive steps:
Production of the sealed wall 111 of the wall 11 of the tank 1 in accordance with a known production process 100, according to another aspect of the invention;
Closure E4 of the sealed wall 111 by applying the base against the sealed wall.

In addition, optionally, the process 200 also comprises the following step:
Consolidation E5 of the sealed wall 111 in order to obtain a reinforced sealed wall.

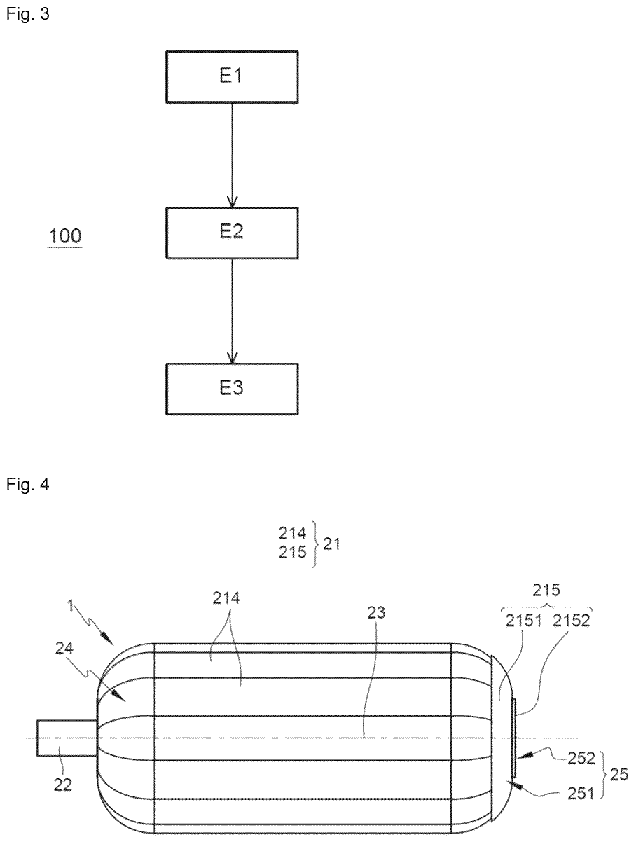

The process 100 for production of the sealed wall 111 is described hereinafter in relation with FIGS. 3 to 10.

With reference to FIG. 3, the process 100 for production of the sealed wall 111 comprises the following steps:
Fitting E1 a reusable and removable mandrel 2 by fitting/dismantling of hoops 24, the mandrel having an outer surface with a form corresponding to the inner surface 111c of the sealed wall 111 of the wall 11 of the tank 1;
Forming E2 the sealed wall 111 of the wall 11 of the tank 1 on the outer surface of the mandrel 2, forming an orifice 111d for extraction of the mandrel 2;
Removing E3 the mandrel 2 from the sealed wall 111 via the extraction orifice 111d.

FIG. 4 illustrates schematically an example of a mandrel 2 fitted, used in the process 100. This mandrel 2 is inspired by document WO2011143723A2.

The mandrel 2 acts as an inner mould for the sealed wall 111.

The mandrel 2 is suitable for the filament winding. In fact, as will be described hereinafter, the step E3 of the process 100 uses a process of this type for filament winding around the mandrel 2.

As shown by FIG. 4, in this case, the mandrel 2 is a hollow part of revolution with an axis of revolution 23.

In this example, the mandrel 2 comprises at one end a removable spindle (or connection) positioned at an axial end of the mandrel 2. In this example, this spindle 22 of the mandrel 2 is designed to be coupled to a rotary motor, making it possible to rotate the mandrel 2 around its axis of revolution 23.

The mandrel 2 also comprises a removable outer surface 21, which is integral with the spindle 22 (once the fitting of the mandrel 2 has been completed).

The outer surface 21 of the mandrel 2 has a rounded form corresponding to the form (and dimensions) of the inner surface 111c of the sealed wall 111 of the wall 11 of the tank 1 (cf. FIG. 2). Thus, according to the example of the tank 1 previously described, in this case the mandrel 2 has an outer surface 21, the largest diameter of which is 60 cm and the length of which is 3.50 m.

The mandrel 2 comprises a plurality of hoops 24, and in this example a base 25. In this case, the base 25 comprises a bottom 251 and a stopper 252 positioned in the bottom 251, but it can be formed in a single piece. The outer surface of the mandrel 21 comprises each outer surface 214 extending axially from each hoop 24, and an outer surface 215 of the base 25, positioned opposite the spindle 22 of the mandrel 2. In this example, the outer surface 215 of the base 25 comprises a bottom outer surface 2151 and a stopper outer surface 2152. Each hoop 24 is retained in position by its opposite ends, one being secured on the circumference 22a of the spindle 22, and the other being engaged in the bottom 251 of the base 25. According to another example, the hoops 24 can also fit into one another.

The mandrel 2 is fitted E1 for example by firstly coupling the spindle 22 on the rotary tooling, then engaging an end of each hoop 24 in the spindle 22, and finally by securing the opposite ends of the hoops 24 with the base 25 of the mandrel 2.

It will be appreciated that other configurations of the mandrel 2 are possible (not represented by the figures).

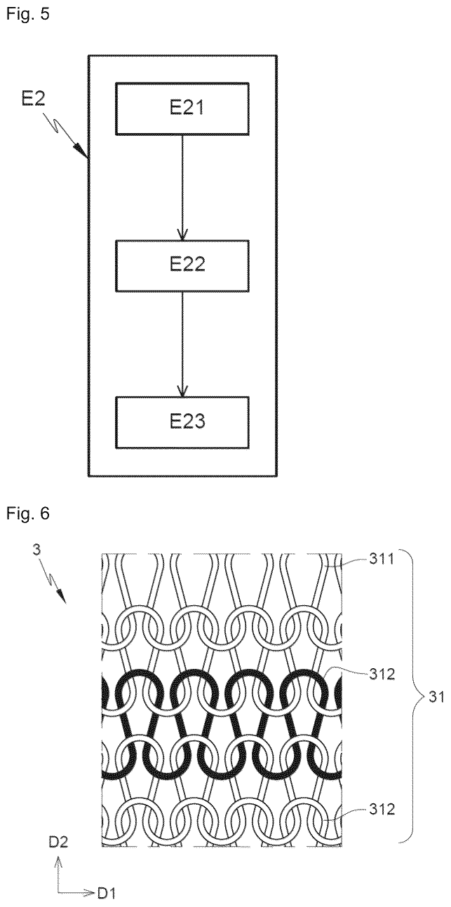

FIG. 5 represents in the form of a logic diagram the step E2 of the process 100. As previously described, this step E2 is intended to form the sealed wall 111 of the wall 11 of the tank 1.

As shown by FIG. 5, the step E2 begins with the sub-step E21. During this sub-step E21, a knitted item 3 is applied on the mandrel 2, covering the outer surface 21 of the mandrel 2.

FIG. 6 represents schematically a partial view of an example of a knitted item 3.

As shown by FIG. 6, the knitted item 3 comprises a layer 31 of knitted threads 311, 312 forming loops. The knitted item 3 is thus a structure which can be formed by loops or mesh passing into one another. For example, the loops or mesh are formed with “heads and feet intertwined”. The knitted item 3 thus forms a material, the meshes of which can be drawn in different directions, and with more elasticity than weaving.

The knitted threads 311, 312 are formed by the, or one of the, thermoplastic materials which can be sealed by heat, of the sealed wall 111 (it should be noted that the sealing is not carried out during the sub-step E21).

The thermoplastic material(s) of the knitted item 3 are for example selected from among (but not limited to) thermoplastic materials of the family of polyolefins or the family of polyamides.

The knitted threads 311, 312 can thus be made of nylon. In this case in particular, the diameter of the knitted threads 311, 312 can be between 0.5 mm and 1 mm.

The knitted threads 311, 312 preferably form loops which are oriented in a first direction D1 and a second direction D2, orthogonal to the first direction D1. The thickness of the knitted threads 311, 312 and/or the geometry of the knitted item, are determined such that the mass per surface area of the knitted item 3, once applied to the outer surface 21 of the mandrel 2, is between 100 g/m² and 800 g/m².

Thus, upon completion of the sub-step E21, the knitted threads 311, 312 of the knitted item 3 form an envelope 30 of knitted threads formed according to the periphery of the outer surface 21 of the mandrel 2. In other words, the envelope 30 of knitted threads has the form of the circumference (of the exterior limits) of the outer surface 21 of the mandrel 2, and is positioned in contact with this outer surface 21. Also in other words, the envelope 30 forms a net which is positioned flat, or draping the outer surface 21 of the mandrel 2.

This envelope 30 of knitted threads provides a first part of the thermoplastic material(s) of the sealed wall 111. As previously described, this or these thermoplastic material(s) is/are necessary in order to provide the barrier effect (impermeability) to the gas or to the liquid to be contained in the interior volume 13 of the tank 1.

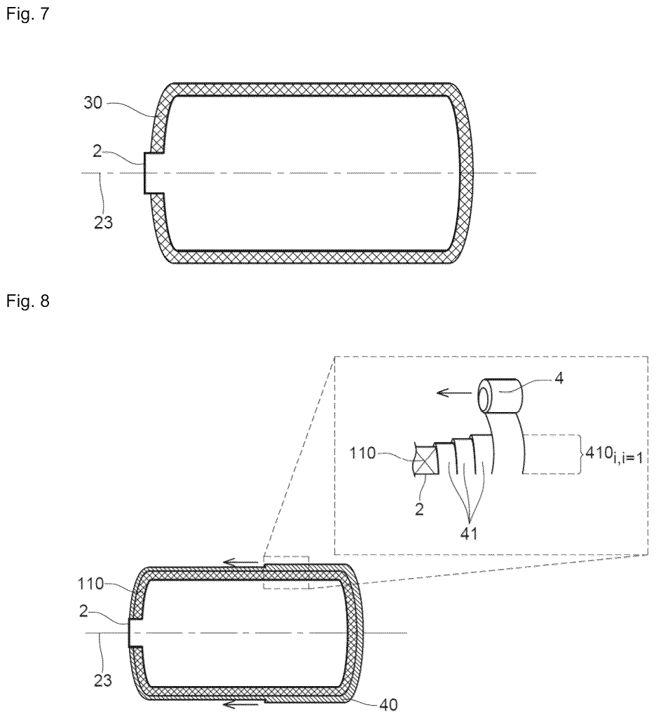

FIG. 7 represents the mandrel 2 obtained upon completion of the step E21, the mandrel being in this case covered by the envelope 30 of knitted threads.

As can be seen in FIG. 7, the envelope 30 does not cover the spindle 22 of the mandrel 22. Thus, when the spindle 22 is removed, during step E3 of the process 100, an orifice will remain (corresponding to the transverse cross-section of the spindle 22), known as the “orifice 111d for extraction of the spindle 2” hereinafter (cf. FIG. 10), via which the hoops 24 and the base 25 of the mandrel 2 can be extracted from the interior of the sealed wall 111. The spindle 22 (and thus the extraction orifice 111d) for this purpose have dimensions depending on the hoops 24 and the bottom 25 and the stopper 26, so that these can be extracted.

In any case, part of the mandrel 2 is not covered by the envelope 30 in order to form the extraction orifice 111d. According to another example, not represented, the envelope 30 does not cover the outer surface 2152 of the stopper 252, thus making it possible to remove the stopper, and forms the extraction orifice 111d or a second extraction orifice. In this example, the spindle 22 can be only an internal shaft, and can be covered by 30, and removed via, the extraction orifice 111d, when the stopper is removed. In this case, the stopper 252 can act as a support and retainer for the mandrel 2, for example by having the axis 23 vertical, during the process for production of the sealed wall.

In practice, the knitted item 3 is produced before execution of the process 100 for production of the sealed tank 1.

It is advantageously in the form of one or a plurality of sleeves (or socks) (not represented by the figures). These sleeves are stretchable and retractable, since they are made only of knitted threads 311, 312.

The sleeve is thus applied on the mandrel 2, for example by an operator, as follows: the sleeve is slipped onto the mandrel 2 via one of the ends of the mandrel 2, in this case via the spindle 22 of the mandrel 2, or via the base 212 of the outer surface 21 of the mandrel 2. The sleeve stretches when it is slipped on, then, once it has been stretched on and released, it retracts onto the outer surface of the mandrel. Thus, the knitted item 3 is deposited flat on the outer surface 21 of the mandrel.

A plurality of sleeves are advantageously used when the dimensions of the mandrel are large (for example when its length is greater than 1 m).

In other cases, use is made of a plurality of mandrels specifically designed to conform to the different forms (diameters) of the outer surface 21 of the mandrel 2. Thus, a sleeve can be used to cover the, or part of the, outer surface 214 of the hoops 24, and another sleeve can be used to cover the outer surface 215 of the base, and optionally one or the other part of the outer surface 214 of the hoops 24. The sleeves can be applied side-by-side, or they can overlap one another axially.

In any case, irrespective of the number of sleeves, and irrespective of the size of the mandrel (in particular its length), the step E21 of application of the knitted item 3 is particularly quick and easy to execute. For example, it takes a trained operator 10 minutes to form the envelope 30 around the mandrel 2. In other words, part of the thermoplastic material(s) of the sealed wall 111 is added simply and rapidly onto the mandrel.

As a variant, another knitted item (not represented by the figures) can be applied on the knitted item 3 previously described. This knitted item is known as the “second knitted item” hereinafter, whereas the knitted item previously deposited is known as the “first knitted item”. The envelope 30 is thus constituted by the two (first and second) superimposed knitted items. This makes it possible to increase the quantity of thermoplastic material of the envelope 30 of knitted threads. This variant is particularly well-suited for increasing the permeability (effect of barrier against the gas) of the sealed wall 111.

When part of the thermoplastic materials has been added (via the envelope 30) onto the outer surface 21 of the mandrel 2, the objective is to add the other part of the thermoplastic materials, as well as the fibres necessary for production of the effect of a barrier against the gas. This addition is carried out during the sub-step E22 described hereinafter, in relation with FIG. 8.

During this sub-step E22, as shown by FIG. 8, and in particular in the insert present in this FIG. 8, successive sections 41 of a first strip 4 of thermoplastic material which can be sealed by heat and reinforced with fibres are coiled (wound) around the envelope 30 of knitted threads.

In other words, during this sub-step E22, a process is carried out of filament winding of the first strip 4 onto the envelope 30, in order to cover the envelope 30 with fibres and thermoplastic material.

The fibres of the first strip 4 are preferably continuous. This makes it possible to obtain a better-performing reinforcement structure, and thus to increase the mechanical resistance to pressure of the resulting sealed wall 111.

The fibres of the first strip 4 are formed from material selected from among (but not limited to) the following materials: glass, carbon, metal, mineral, wool, cotton, linen, polyester, polypropylene, polyamide, basalt, Kevlar®, drawn thermoplastic, or a mixture of two or more of these materials.

The thermoplastic material of this first strip 4 is chemically compatible with the thermoplastic material of the knitted threads 311, 312. The expression “chemically compatible” means that the thermoplastic materials of the knitted item 3 and of the first strip 4 have points of melting and/or of softening situated in identical or close temperature ranges.

The thermoplastic material which can be sealed by the addition of heat, of the first strip 4, can be identical to that of the knitted threads 311, 312. For example, the thermoplastic material of the first strip and that of the knitted threads can both be of the polyolefin family, or also of the polyamide family.

The effect produced by this compatibility of the thermoplastic materials of the first strip 4 and of the knitted threads 3 will be described subsequently, in relation with the sub-step E23.

The first strip 4 preferably has a width of 20 cm or more, for example equal to 20 cm, 50 cm or more. This makes it possible to make the execution of the sub-step E22 more rapid than when the first strip has a smaller width.

It will be appreciated that a first strip 4 with a width smaller than 20 cm is suitable for the process 100, for example a width of first strip 4 equal to 2 cm, or 4 cm, or also 14 cm is suitable.

In practice, the mandrel 2 is rotated in this example by the spindle 22 during the execution of the sub-step E22. According to another example, the mandrel 2 and the envelope 30 are immobile and a winder rotates around the mandrel 2 for the filament winding of the first strip 4 on the envelope 30, in order to cover the envelope 30 with fibres and thermoplastic material. As explained hereinafter, the strip is wound while being clamped on the envelope 30, thus exerting a pressure between the strip 4 and the envelope 30 during the filament winding at a temperature in a predetermined temperature range, in order for the strip 4 to melt or be joined with the envelope 30.

As illustrated schematically by the insert of FIG. 8, the successive wound sections 41 of the first strip 4 overlap in order to form a first layer 410₁ of first strip 4, and overlap in order to form superimposed layers 40 of first strip 4 (on the insert of FIG. 8, a second layer superimposed on the first layer 410₁, i=1 is about to be formed, in the axial direction of the arrow). The number n1 of superimposed layers of this first strip 4 depends on the diameter and the geometric form of the mandrel 2 (and thus on the diameter and form of the interior volume 13 desired for the tank 1), as well as on the desired bursting pressure (i.e. the pressure above which the tank 1 no longer resists the pressure, and is deformed). The number n1 of layers can be between n1=2 and several hundred, for example n1=200. The multi-layer winding makes it possible to reduce the permeability, and to increase the mechanical resistance to pressure of the resulting 1 sealed wall 111.

The thickness of each layer 410₁, i=1 to n can for example be between 50 μm and 300 μm. Within each layer 410₁, i=1 to n, the successive sections 41 of first strip overlap over a distance of between 0 (corresponding to no overlapping) and half the width of the first strip 4, and according to overlapping angles which can vary.

During the winding of the first strip 4, pressure and heating are applied to each successive wound section 41 of the first strip 4.

The pressure applied to each section 41 of wound first strip is determined in order 1) during the formation of the first layer 410i, i=1, to clamp this section 41 against the envelope 30 of knitted threads, and 2) during the formation of the superimposed layers 410i, i=2 to n1, to clamp this section 41 against the underlying layer 410i-1 of first strip 4.

The heating temperature applied to each section 41 of first wound strip is determined according to the properties of the thermoplastic material(s) used (in the first strip 4, in the envelope 30 of knitted threads). More specifically, the temperature is situated in the melting range of the thermoplastic materials used (this range being common since the thermoplastic materials are compatible).

Thus, during the formation of the first layer 410i, i=1 of first strip 4, the thermoplastic material of each wound section 41 melts, or is joined with, the underlying threads of the envelope 30 of knitted threads. In addition, during the formation of the superimposed layers of first strip 4, the thermoplastic material of each wound section 41 melts, or is joined with, the underlying layer 410i-1 of first strip 4.

In other words, the temperature is selected in order to melt the thermoplastic material of each section of the first layer of first strip with the underlying threads of the envelope of knitted threads, and to melt the sections of the successive layers of first strip.

For example, when the thermoplastic materials concerned are of the polyolefin or polyamide families, the temperature is between 160° C. and 340° C.

Under the effect of the heat and the clamping, the fibres of the layers 410i, i=1 to n1 of the first strip 4 are also joined against the thermoplastic material(s) (of the first strip 4, of the envelope 30 of knitted threads).

Thus, upon completion of the sub-step E22, the envelope 30 and the assembly of the superimposed layers 40 of first strip are joined, or consolidated, into a single material.

The expression “a single material” is understood in this case as having homogeneousness such that it is impossible to distinguish the materials used to produce it by means of the naked eye. Thus, the expression “made of a single material” designates a monolithic structure as opposed to a sealed wall which would be constituted by two concentric envelopes.

As a variant, the sub-step E22 is carried out not with a single first strip 4, but with at least one other additional strip, formed by the material of the first strip, with the additional strip being wound simultaneously with the first strip 4. This makes it possible to speed up the execution of this sub-step E22, and thus to make the process 100 for production of the sealed wall 111 faster.

The process 100 for production of the sealed wall 111 also comprises a sub-step E23 during the step E2. During this sub-step E23, cooling of the envelope 30 and the assembly of the superimposed layers 40 of first strip is implemented in order to rigidify them. This therefore provides a sealed block 130, which is the sealed wall 111 of the tank 1. This block 130 is separable from the mandrel 2.

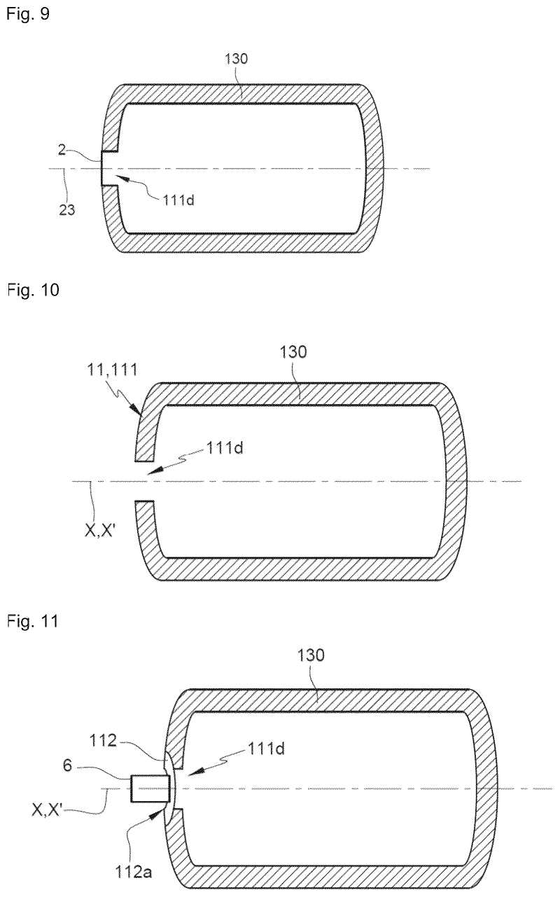

FIG. 9 illustrates the block 130, and thus the sealed wall 111, obtained upon completion of the sub-step E23. It will be noted that this block 130 (like the envelope 30 of knitted threads) has the extraction orifice 111d, which is positioned at the location of the spindle 22 of the mandrel 2.

With reference to FIG. 3, step E3 of the process 100 for production of the sealed wall 111 is implemented after the step E2. This step E3 is illustrated in schematic form in FIG. 10.

As shown by FIG. 10, step E3 consists of dismantling the mandrel 2 and extracting it from the interior of the block 130 via the extraction orifice 111d.

In practice, during the step E3, the spindle 22 of the mandrel 2 is firstly dismantled, then the hoops 24 are dismantled and removed via the extraction orifice 111d of the block 130, and finally, the base 25 is dismantled and also removed via the extraction orifice 111d.

Upon completion of step E3, the block 130 from which the mandrel 2 has been removed forms the sealed wall 130, 111 of the tank 1. This sealed wall 130, 111 is thus made of a single material (cf. FIG. 10).

Thanks to the consolidation of the envelope 30 of knitted threads with the layers 40 of first wound strip 4, the sealed wall 130, 111 has properties of impermeability and mechanical resistance to pressure similar to those of the tank described in document WO2011143723A2, while being faster to produce.

In fact, in order to form the layer which is a barrier against the gas, it is no longer to produce the first filament winding with the thermoplastic material. This step, which is lengthy (in the example of the tank 1, it requires more than three hours), is no longer necessary because it is replaced by the sub-step E21 of the process 100, which consists of forming the envelope 30 of knitted threads.

As previously described, this sub-step E21 is rapid (10 minutes are sufficient in the example of the tank 1), because the knitted item 3 is previously produced, because it is very fast and easy to apply to the mandrel 2, and, finally, because a single layer 31 of knitted threads is enough to provide a sufficient quantity of thermoplastic material. In fact, adapting the knitting parameters provides a sufficient gram weight of knitted item, thus making it possible to use a single layer of knitted threads.

In addition to its speed of execution, the joining of the envelope 30 of knitted threads with the superimposed layers 40 of first strip makes it possible to produce the sealed wall 130 in a single material. This homogeneous material has a plurality of advantages: 1) it increases the resistance to the internal pressure of the sealed wall 130, and 2) it increases the impermeability in relation to the liquids. This therefore makes it possible to obtain a sealed wall 130 which is better made and is more resistant in the long term (or, in other words, has a longer service life).

Finally, it should be noted that the thickness of this knitted item 3 is smaller than the thickness of a conventional liner.

When the sealed wall 130 has been produced, the process 200 for production of the tank 1 continues by implementation of the steps E4 and E5 (cf. FIG. 1).

FIG. 11 illustrates schematically the step E4 (second step of the production process 200).

As shown by FIG. 11, during the step E4, the bottom 112 of the wall 11 of the tank 1 (cf. FIG. 2) is applied against the sealed wall 130, such as to close the extraction orifice 111d.

For example, the bottom 112 can be welded against the sealed wall 130, on the periphery of the extraction orifice 111d. In another example, the bottom 112 can be fitted into the extraction orifice 112.

The interior passage of the bottom 112 has a diameter which is reduced in comparison with the diameter of the spindle 22. In this example, this interior passage is advantageously designed to receive a second spindle 6 (cf. FIG. 11), in order to permit the rotation of the sealed wall 130 around its axis XX′.

The outer periphery 112a of the bottom 112 can advantageously be formed by a thermoplastic material which can be sealed by heat, and is compatible with the material of the sealed wall 130 (i.e. compatible with the thermoplastic material of the knitted threads, and thus compatible with the thermoplastic material of the first strip 4).

For example, the bottom 112 can be formed entirely of this thermoplastic material, or have only an over-moulding of this material positioned on its outer periphery 112a (in this case, the remainder of the bottom can be made of metal). The over-moulded bottom can be easily welded against the sealed wall 130.

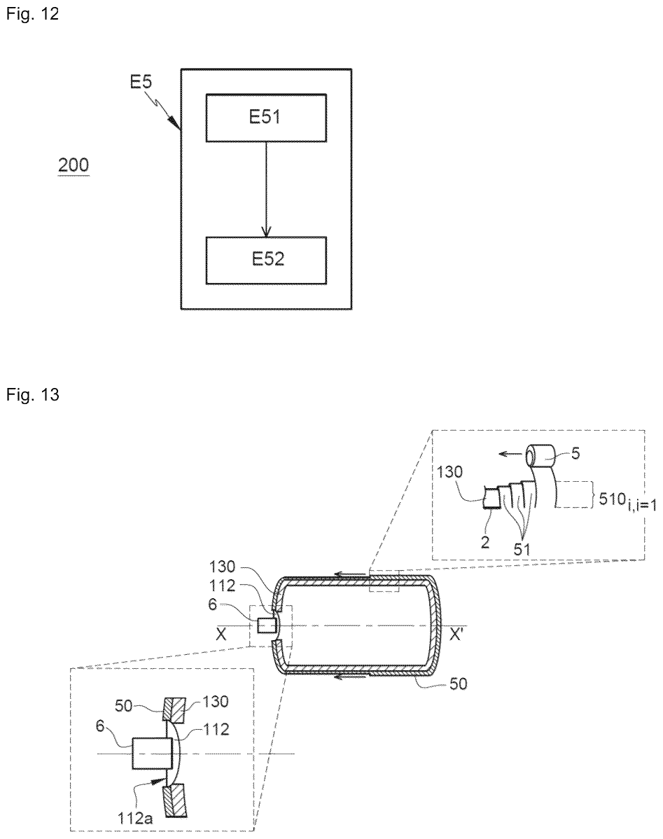

FIG. 12 represents, in the form of a logic diagram, the step E5 of the process 200 for production of the sealed tank 1. This step E5 is intended to reinforce, or consolidate, the sealed wall 130, with a fibrous material, in order to obtain a reinforced sealed wall 150, which can thus withstand mechanically pressures greater for example than 2 MPa. The sealed wall 111 of the tank 1 is thus the reinforced sealed wall 150.

As shown by FIG. 12, for this purpose, this step E5 comprises a sub-step E51 comprising a filament winding, and a sub-step E52 of cooling of the winding.

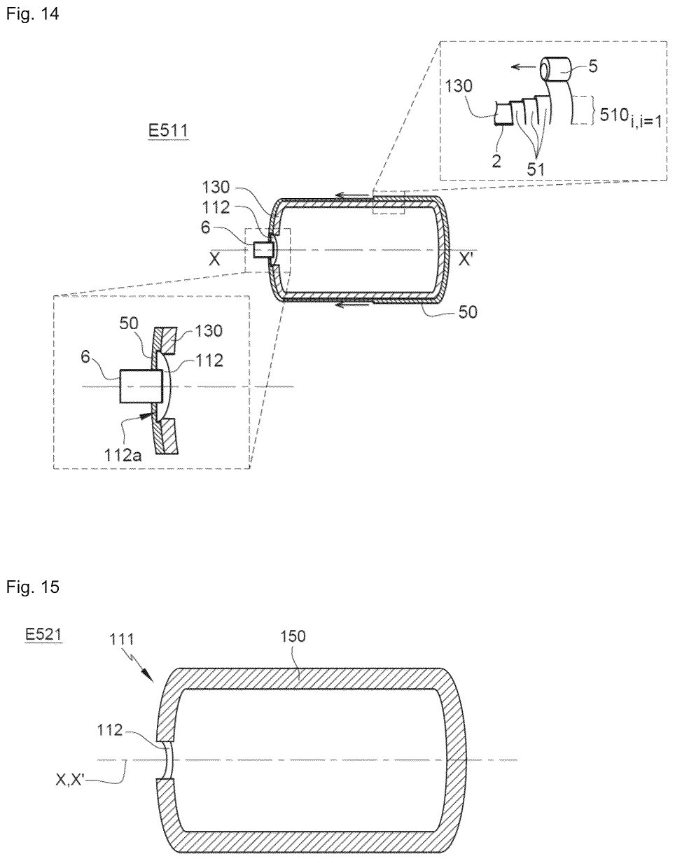

Two embodiments of the sub-step E51 are described hereinafter, in relation with FIGS. 13 and 14.

In its simplest embodiment (also known as the “first embodiment E51” hereinafter), illustrated in FIG. 13, the sub-step E51 consists of winding successive sections 51 of a second strip 5 of thermoplastic material which can be sealed by heat and is reinforced with fibres, around the sealed wall 130.

The thermoplastic material of the second strip 5 is chemically compatible with the thermoplastic material of the first strip 4, and thus with the thermoplastic material of the knitted threads 311, 312. It can be noted that the material of the second strip 5 is thus also compatible with the thermoplastic material of the outer periphery 112a or the outer surface of the bottom 112 (in the case when this surface is formed of a thermoplastic material).

The second strip 5 is similar to the first strip 4 in that it can have the same width, or also fibres of the same type and/or the same weaving geometry.

In practice, the sealed wall 130 can be rotated (for example via the spindle 6).

The process of winding (or wrapping) the second strip 5 is similar to that of the first strip 4. Thus, as illustrated by FIG. 13, the successive wound sections 51 of the second strip 5 overlap in order to form a first layer 510i, i=1 of second strip 5, and overlap in order to form superimposed layers 50 of second strip 5. The number n2 of superimposed layers depends on the dimensions of the tank 1, and can be between n2=2 and several hundred, for example n2=200.

The multi-layer winding of the second strip 5 makes it possible to increase the permeability, the mechanical strength and resistance to pressure of the reinforced sealed wall 150 (and thus of the sealed wall 111 of the tank 1) in comparison with a winding which would have only the first layer 510i, i=1.

The thickness of each layer 510i, i=1 to n2 of the second strip 5 can for example be between 50 μm and 300 μm. Within a single layer of second wound strip, the axial overlapping distance can for example be between 0 (corresponding to no overlapping) and half the width of the second strip 5.

During the winding E51 of second strip 5, as during the winding E22 of the sections 41 of first strip 4, pressure and heating are applied to each wound section 51.

More specifically, the pressure applied to each section 51 of second wound strip is determined in order to:
1) clamp this section 51 against the exterior limits of the sealed wall 130; and
2) clamp this section 51 against the underlying layer 510i, i=1 to n2 of second strip (during the formation of the superimposed layers of second strip 5).

The temperature of the heating applied to each wound section 51 of second strip can be identical to the temperature applied during the winding of the first strip 4. Alternatively, the temperature of the heating applied to each wound section 51 of second strip is close, i.e. situated in the melting temperature range of the thermoplastic materials used.

Thus, the thermoplastic material of each wound section 51 of second strip 5 melts with the underlying region of the sealed wall 130, and melts with the underlying layer of second strip (during the formation of the superimposed layers of second strip).

Upon completion of the sub-step E51, the superimposed layers 50 of second strip 5 are joined with the sealed wall 130 in order to form the reinforced sealed wall 150 made of a single material.

During the sub-step E52, the second wound strip and the sealed wall 130 are cooled, and thus rigidified, in order for the reinforced sealed wall 150 to be consolidated and rigid. The reinforced sealed wall 150 thus forms the sealed wall 111 of the tank 1.

The cooling can be carried out after the sub-step E51, i.e. once the winding of the second strip 5 has been completed.

Alternatively, the cooling can be carried out locally, during the winding E51 of the second strip 5.

The cooling E52 can be carried out in a regulated manner by injecting into the interior of the sealed wall 130 cooled water, and/or by applying pressure to the inner surface of the sealed wall 130.

FIG. 14 represents a preferential embodiment E511 of the sub-step E51. According to this preferential embodiment, the sub-step E511 consists of winding the successive sections 51 of the second strip 5 not only around the sealed wall 111, but also on the outer surface 112a of the bottom 112.

Upon completion of the sub-step E511, the superimposed layers 50 of second strip 5 thus also overlap the outer periphery 112a of the bottom 12.

When the outer periphery 112a of the bottom is covered with the thermoplastic material compatible with the thermoplastic material of the sealed wall 111, the superimposed layers 50 of second strip 5 are joined with the sealed wall 111 and with the outer periphery 112a of the bottom 112. The reinforced sealed wall 150 (and thus the sealed wall 111 of the tank 1) is therefore extended as far as the circumference of the spindle 6, and is formed by a single material.

After having carried out cooling E521 according to the process previously described in relation with the sub-step E52, the structure illustrated in FIG. 15 is obtained.

As shown by FIG. 15, thanks to the preferential embodiment E511, the reinforced sealed wall 150 (and thus the sealed wall 111 of the tank 1) is extended as far as the periphery of the interior passage of the base 112. In other words, the base 112 is partly incorporated in the thickness of the sealed wall 111. This makes it possible to prevent ruptures of resistance to pressure around the tap of the tank 1, and thus to obtain a tank 1 which is sealed and mechanically resistant to the pressures involved.

It can be noted that the sealed wall 111 of the tank 1 obtained by implementing the sub-step E511 is advantageously more homogeneous than that obtained according to the first embodiment E51. In fact, this sealed wall 111 is thus formed around its entire periphery by the same reinforced material. This makes it possible to obtain a tank 1 having properties of impermeability, and mechanical properties, which are identical at all points of its sealed wall 111. This (spatial) homogeneousness of the sealed wall 111 makes it possible to produce a better-made tank 1.

Finally, after the step E5, the process 100 can comprise a step (not represented by the figures) consisting of applying the tap 122 of the joining piece 12 of the tank 1 in the interior passage of the bottom 112. The tank 1 illustrated in FIG. 2 is thus obtained.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A process for production of a sealed wall of a sealed tank, the sealed tank being designed to contain a gas and/or a liquid, with the production process comprising the following steps:
fitting a reusable and removable mandrel by fitting/dismantling of hoops, the mandrel having an outer surface with a form corresponding to an inner surface of the sealed wall of the tank;
forming the sealed wall of the tank on the outer surface of the mandrel, while forming an orifice for extraction of the mandrel;
removing the mandrel from the sealed wall through the extraction orifice; wherein the step of forming the sealed wall is performed by carrying out the following sub-steps of:
forming an envelope by application of at least one knitted item covering the outer surface of the mandrel, the knitted item comprising a layer of knitted threads forming loops, the knitted threads being made of a thermoplastic material which can be sealed by the addition of heat;
winding, around the envelope formed by the knitted item covering the outer surface of the mandrel, of successive sections of a first strip comprising a thermoplastic material which can be sealed by the addition of heat and is reinforced by fibres, such that the successive sections of first wound strip overlap in order to form a first layer of first strip, and overlap in order to form superimposed layers of first strip, the winding being carried out by:
exerting a pressure selected to clamp each section of the first wound strip against the envelope, forming the first layer of first strip, and to clamp the sections covering the first layer of first strip, in order to form the other superimposed layers of first strip, and by:
applying a temperature selected in order to melt the thermoplastic material of each section of the first layer of first strip together with the underlying knitted treads of the envelope, and to melt the sections of the successive layers of first strip;
cooling the envelope and the first wound strip in order to form the sealed wall in a single material.

2. The process for production of a sealed wall according to claim 1, wherein the thermoplastic material of the knitted threads is identical to the thermoplastic material of the first strip.

3. The process for production of a sealed wall according to claim 1, wherein the knitted item has a mass per surface area of between 100 g/m² and 800 g/m².

4. The process for production of a sealed wall according to claim 1, wherein the knitted item is in the form of one or a plurality of sleeves, each sleeve being slipped onto an end of the mandrel.

5. The process for production of a sealed wall according to claim 1, wherein the sub-step of formation of the envelope also comprises the application of a second knitted item onto the first knitted item, with the thermoplastic material of the knitted threads of the second knitted item being able to be sealed by addition of heat under the same temperature and pressure conditions as the thermoplastic material of the knitted threads of the first, underlying knitted item.

6. The process for production of a sealed wall according to claim 1, wherein the sub-step of winding around the envelope comprises winding of at least one other additional strip, formed by the material of the first strip, with the additional strip being wound simultaneously with the first strip.

7. A process for production of a sealed tank to contain a gas or liquid, comprising the following steps:
producing a sealed wall of the tank by carrying out the steps of the production process according to claim 1;
closing the sealed wall by applying a base against the sealed wall;
consolidating the sealed wall in order to obtain a reinforced sealed wall of the tank;
the step for consolidation of the sealed wall being carried out by performing the following sub-steps of:
winding, around the sealed wall, of successive sections of a second strip comprising a thermoplastic material which can be sealed by heat, and is reinforced by fibres, such that the successive sections of second wound strip overlap in order to form a first layer of second strip, and overlap in order to form superimposed layers of second strip, the winding being carried out by:
exerting pressure selected in order to clamp each section of the second wound strip against the sealed wall, forming the first layer of second strip, and in order to clamp the sections overlapping the first layer of second strip in order to form the other superimposed layers of second strip; and by
applying a temperature selected in order to melt the thermoplastic material of each section of the first layer of second strip together with the underlying region of the sealed wall, and to melt the sections of the successive layers of second strip;
cooling of the sealed wall and of the second strip in order to form the reinforced sealed wall made of a single material.

8. The process for production of a sealed tank according to claim 7, wherein the thermoplastic materials of the first and of the second strip are identical.

9. The process for production of a sealed tank according to claim 7, wherein the bottom has a peripheral outer surface covered by a thermoplastic material which can be sealed by heat, and is compatible with the thermoplastic material of the sealed wall.

10. The process for production of a sealed tank according to claim 7, wherein the outer surface of the bottom is covered by the second strip during the said step of consolidation of the sealed wall.
